(19) United States
(12) Patent Application Publication
(10) Pub. No.: US 2026/0016562 A1
(43) Pub. Date: Jan. 15, 2026

(54) RADAR DEVICE

(71) Applicant: DENSO CORPORATION, Kariya-city (JP)

(72) Inventors: SATORU SHIMIZU, Kariya-city (JP); CHIHIRO ARAI, Kariya-city (JP); YUKOU MURASE, Kariya-city (JP); OSAMU ISAJI, Kariya-city (JP)

(21) Appl. No.: 19/338,924

(22) Filed: Sep. 24, 2025

Related U.S. Application Data
(63) Continuation of application No. PCT/JP2024/010140, filed on Mar. 15, 2024.

(30) Foreign Application Priority Data
Mar. 30, 2023 (JP) 2023-055858

(51) Int. Cl. G01S 7/35

(52) U.S. Cl. CPC G01S 7/352

(57) ABSTRACT

A radar device includes transmission and reception antennas, transmission circuits to output transmitted signals, and receiver circuits to acquire received signals. A controller processes these received signals. The number of transmission antennas, Ns, and reception antennas, Nr, are two or more and are arranged at unequal intervals. The antennas are configured so that the number of first combinations of transmission and receiver circuits is at least Ns+Nr−2. A first combination is determined by assuming virtual antennas based on phase differences of received signals and extracting sets of virtual antennas with overlapping positions. The controller compensates for phase or amplitude differences between different transmission and receiver circuits based on comparison results of received signals between the virtual antennas in at least Ns+Nr−2 sets of first combinations.

### CROSS REFERENCE TO RELATED APPLICATIONS

The present application is a continuation application of International Patent Application No. PCT/JP2024/010140 filed on Mar. 15, 2024, which designated the U.S. and claims the benefit of priority from Japanese Patent Application No. 2023-055858 filed on Mar. 30, 2023. The entire disclosures of all of the above applications are incorporated herein by reference.

### TECHNICAL FIELD

The present disclosure relates to radar technology.

### BACKGROUND

A conventional radar device includes reception antennas provided in receiver circuits, transmission antennas, and a phase compensation unit.

### SUMMARY

According to at least one embodiment, a radar device includes transmission antennas and reception antennas. The device has transmission circuits each connected to the transmission antennas to output transmitted signals. The device also has receiver circuits each connected to the reception antennas to acquire received signals. A controller processes the received signals. A number of the transmission antennas is two or more, and is represented by Ns. A number of the reception antennas is two or more, and is represented by Nr. The transmission antennas and/or the reception antennas are arranged at unequal intervals. The transmission antennas and the reception antennas are arranged such that a number of first combinations of the transmission circuit and the receiver circuit is at least Ns+Nr−2. A first combination is one of the first combinations. The first combination is determined by first assuming a virtual antenna for each of the transmission antennas based on a phase difference of the received signals between the reception antennas. Then, a collection of sets of virtual antennas whose virtual positions overlap and whose combinations of the transmission circuits and the receiver circuits do not match is extracted. Finally, among the extracted collection, combinations of virtual antennas whose combinations of the transmission circuits and the receiver circuits are not duplicated with those of other combinations are determined as the first combination. The controller performs a compensation process to compensate for at least one of a phase difference or an amplitude difference between different transmission circuits. It also compensates for at least one of a phase difference or an amplitude difference between different receiver circuits, based on a comparison result of the received signals between the virtual antennas in at least Ns+Nr−2 sets of the first combinations.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic diagram illustrating a configuration of a radar device according to a first embodiment.

FIG. 2 is a schematic diagram illustrating an example of a combination of a transmission circuit and a transmission antenna, and a receiver circuit and a reception antenna according to the first embodiment.

FIG. 3 is a schematic diagram illustrating an example of an arrangement of the transmission antenna and the reception antenna according to the first embodiment.

FIG. 4 is a schematic diagram illustrating virtual antennas assumed according to the first embodiment.

FIG. 5 is a table showing an example of a set of virtual antennas used in a compensation process.

FIG. 6 is a block diagram illustrating a functional configuration of a control unit according to the first embodiment.

FIG. 7 is a flowchart illustrating a control flow according to the first embodiment.

FIG. 8 is a schematic diagram illustrating an example of a combination of a transmission circuit and a transmission antenna, and a receiver circuit and a reception antenna according to a second embodiment.

FIG. 9 is a schematic diagram illustrating an example of an arrangement of the transmission antenna and the reception antenna according to the second embodiment.

FIG. 10 is a schematic diagram illustrating virtual antennas assumed according to the second embodiment.

FIG. 11 is a schematic diagram illustrating overlapping antennas.

FIG. 12 is a schematic diagram illustrating an example of a combination of a transmission circuit and a transmission antenna, and a receiver circuit and a reception antenna according to a third embodiment.

FIG. 13 is a schematic diagram illustrating an example of an arrangement of the transmission antenna and the reception antenna according to the third embodiment.

FIG. 14 is a schematic diagram illustrating virtual antennas assumed according to the third embodiment.

FIG. 15 is a graph illustrating a relationship between a wiring length difference and a phase error.

FIG. 16 is a table showing an example of a set of virtual antennas used in a compensation process.

FIG. 17 is a graph illustrating a relative relationship of a wiring length according to a fourth embodiment.

FIG. 18 is a schematic diagram illustrating an example of an arrangement of a transmission antenna and a reception antenna according to another embodiment.

FIG. 19 is a schematic diagram illustrating a virtual position of a virtual antenna in the other embodiment.

### DETAILED DESCRIPTION

To begin with, examples of relevant techniques will be described.

A radar device according to a comparative example includes reception antennas in receiver circuits, a first transmission antenna, a second transmission antenna, and a phase compensation unit. The first transmission antenna and the second transmission antenna are provided at a predetermined distance from the reception antenna so that positions of the reception antennas virtually overlap. The phase compensation unit compensates for a phase difference between the receiver circuits of reflected waves of each transmission wave transmitted from the first and second transmission antennas based on a comparison result of each received signal received by each reception antenna arranged to virtually overlap.

In the radar device according to the comparative example, only the phase difference between different receiver circuits can be compensated for. However, there are other factors that cause errors in different received signals besides differences in the receiver circuits. Therefore, compensation accuracy may decrease. In addition, in the radar device of the comparative example, spatial resolution may be reduced because an aperture length is shortened by a certain amount of virtual overlap of the reception antennas. Therefore, achieving both the compensation accuracy and the spatial resolution is difficult for the radar device of the comparative example.

In contrast to the comparative example, according to a radar device of the present disclosure, both compensation accuracy and spatial resolution can be achieved.

Hereinafter, a technical solution of the present disclosure to address the above described objectives will be described.

According to one aspect of the present disclosure, a radar device includes transmission antennas and reception antennas. The device has transmission circuits each connected to the transmission antennas to output transmitted signals. The device also has receiver circuits each connected to the reception antennas to acquire received signals. A controller processes the received signals. A number of the transmission antennas is two or more, and is represented by Ns. A number of the reception antennas is two or more, and is represented by Nr. The transmission antennas and/or the reception antennas are arranged at unequal intervals. The transmission antennas and the reception antennas are arranged such that a number of first combinations of the transmission circuit and the receiver circuit is at least Ns+Nr−2. A first combination is one of the first combinations. The first combination is determined by first assuming a virtual antenna for each of the transmission antennas based on a phase difference of the received signals between the reception antennas. Then, a collection of sets of virtual antennas whose virtual positions overlap and whose combinations of the transmission circuits and the receiver circuits do not match is extracted. Finally, among the extracted collection, combinations of virtual antennas whose combinations of the transmission circuits and the receiver circuits are not duplicated with those of other combinations are determined as the first combination. The controller performs a compensation process to compensate for at least one of a phase difference or an amplitude difference between different transmission circuits. It also compensates for at least one of a phase difference or an amplitude difference between different receiver circuits, based on a comparison result of the received signals between the virtual antennas in at least Ns+Nr−2 sets of the first combinations.

According to this configuration, at least one of the phase difference and the amplitude difference between different transmission circuits and at least one of the phase difference and the amplitude difference between different receiver circuits can be compensated for based on the comparison result between the received signals of the virtual antennas in at least Ns+Nr−2 unique sets. Therefore, the error compensation processing can be performed not only between different receiver circuits but also between different transmission circuits. Furthermore, by arranging at least one of the transmission antennas and the reception antennas at uneven intervals, an aperture length of the virtual antenna can be made larger than in a case where the antennas are arranged at equal intervals. Therefore, both compensation accuracy and spatial resolution can be achieved.

The following will describe embodiments of the present disclosure with reference to the drawings. It should be noted that the same reference numerals are assigned to corresponding components in the respective embodiments, and overlapping descriptions may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the plurality of embodiments can be partially combined together even if the configurations are not explicitly shown if there is no problem in the combination in particular.

### First Embodiment

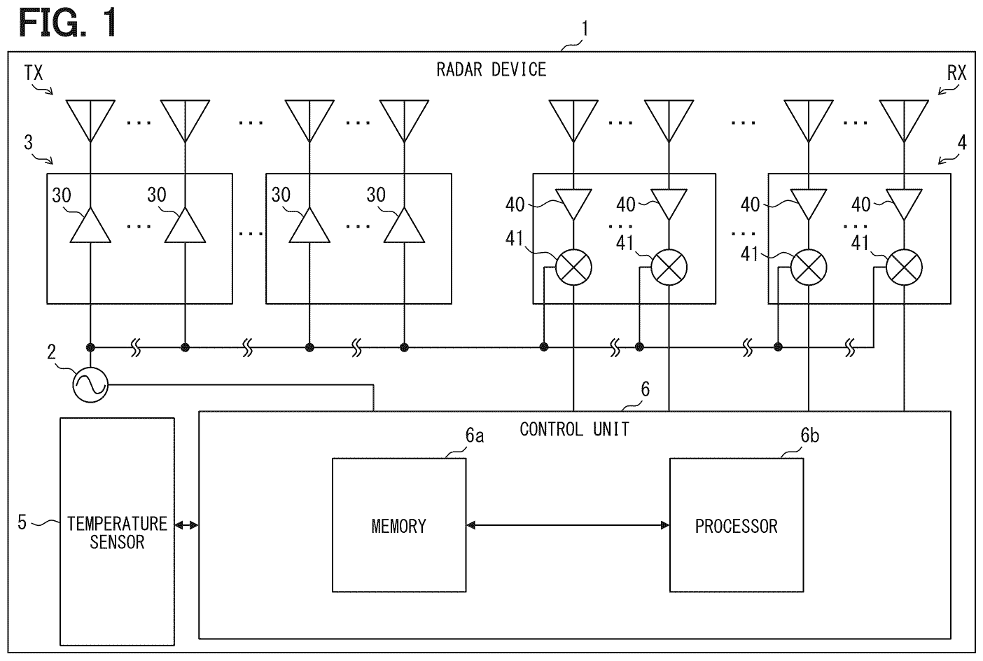

A first embodiment of the present disclosure will be described with reference to FIGS. 1 to 7. A radar device 1 is mounted on a moving object such as a vehicle. The radar device 1 transmits a transmitted signal, receives the transmitted signal reflected by an object as a received signal, and detects target information such as a distance to the target, which is the object that reflected the transmitted signal, a relative velocity to the target, and a direction of the target.

The target information output from the radar device 1 is input to an in-vehicle ECU (electronic control unit) via an in-vehicle network such as a Control Area Network (CAN) (registered trademark) or Ethernet (registered trademark). The in-vehicle ECU executes various processes for automated driving of the vehicle and advanced driving assistance based on the acquired target information of each target.

The processes based on the target information include, for example, collision avoidance processes and warning processes. The collision avoidance process is a process of controlling the vehicle to avoid collision with the targets by controlling a brake system and a steering system based on the target information of each target. The warning process is a process for warning a driver of a possibility of a collision with a target based on the target information of each target.

As shown in a basic configuration of FIG. 1, the radar device 1 of the present embodiment includes an oscillator 2, transmission circuits 3, transmission antennas TX, reception antennas RX, receiver circuits 4, a temperature sensor 5, and a control unit 6. The radar device 1 is a so-called MIMO (Multiple-Input-Multiple-Output) radar that transmits transmitted signals from multiple transmission antennas TX to artificially increase the number of reception antennas RX beyond the actual number.

The oscillator 2 receives a control signal from the control unit 6, and generates a modulated signal modulated in response to the control signal. The modulated signal is, for example, a so-called chirp signal whose frequency changes over time. The modulated signal is distributed and output on each channel of the transmission circuits 3 and the receiver circuits 4. In the following, the modulated signal output from the oscillator 2 to the transmission circuits 3 is referred to as a transmitted signal. Moreover, the modulated signal output from the oscillator 2 to the receiver circuits 4 is used as a local signal.

The transmission circuits 3 and the receiver circuits 4 are each mainly composed of a semiconductor integrated circuit device such as an MMIC (Monolithic Microwave Integrated Circuit). The transmission circuits 3 are connected to the transmission antennas TX and outputs the transmitted signal to the transmission antennas TX. When the number of transmission circuits 3 mounted on one radar device 1 is “Ns”, Ns is an integer equal to or greater than two. A transmission circuit 3 of the transmission circuits 3 includes amplifiers 30 in the same number as the number of connected transmission antennas TX. The amplifiers 30 amplify the transmitted signals output from the oscillator 2 and output the amplified signals to the corresponding transmission antennas TX.

The transmission antenna TX converts an electrical signal, which is a transmitted signal supplied from the oscillator 2, into a radio wave signal and transmits it to an external environment. A transmission antenna TX of the transmission antennas TX includes at least one antenna element. For example, the transmission antenna TX is a patch antenna having flat-plate-shaped antenna elements. The antenna element is provided on a dielectric substrate. The dielectric substrate has a surface on which a ground plane is provided and a surface on which the antenna element is provided. The antenna element is provided on the dielectric substrate in a position facing the ground plane. The multiple antenna elements are connected, for example, in series, by a feed line that supplies an electric signal.

A reception antenna RX of the reception antennas RX receives, as a received signal, a radio wave signal including a transmitted signal reflected from a target in the external environment as a reflecting object. The reception antenna RX is connected to a corresponding receiver circuit 4. An arrangement of the transmission antennas TX and the reception antennas RX will be described later.

The reception antenna RX converts the received signal, which is a radio wave signal, into an electric signal and outputs it to the corresponding receiver circuit 4. The reception antenna RX is, for example, a patch antenna having at least one antenna element connected in series by a feeder line, similar to the transmission antenna TX.

A receiver circuit 4 of the receiver circuit 4 is connected to a reception antenna RX and acquires a received signal received by the reception antenna RX. When the number of receiver circuits 4 mounted on one radar device 1 is “Nr”, Nr is an integer equal to or greater than two. The receiver circuit 4 includes amplifiers 40 and signal mixing units 41, the number of which is equal to the number of reception antennas RX connected.

An amplifier 40 amplifies the received signal received by the reception antenna and outputs the amplified signal to a signal mixing unit 41. The signal mixing unit 41 generates a beat signal by mixing the local signal from the oscillator 2 with the received signal. The generated beat signal is an interference signal that represents a frequency difference between the received signal and the local signal. The beat signal is output to the control unit 6 as signal data related to the received signal, after high-frequency components that deviate from the frequency difference between the received signal and the local signal have been filtered out by a low-pass filter (not shown).

The temperature sensor 5 detects a temperature inside the radar device 1. The temperature sensor 5 includes, for example, a thermistor, and outputs temperature information according to a resistance value of the thermistor. The temperature sensor 5 detects temperature information of each of the transmission circuits 3 and the receiver circuits 4 and outputs the information to the control unit 6.

The control unit 6 includes at least one dedicated computer. The dedicated computer constituting the control unit 6 may be an electronic control unit (ECU) specialized for controlling the radar device 1.

The dedicated computer constituting the control unit 6 has at least one memory 6a and at least one processor 6b. The memory 6a is at least one type of non-transitory tangible storage medium out of, for example, a semiconductor memory, a magnetic medium, an optical medium, and the like that non-transitorily store a computer readable program, data, and the like. Here, the memory 6a may accumulate and retain data even when a sensor system is turned off, or may temporarily store data by deleting the data when the sensor system is turned off. The processor 6b includes a processing core as at least one type of, for example, a CPU (i.e., Central Processing Unit), a GPU (i.e., Graphics Processing Unit), a RISC (i.e., Reduced Instruction Set Computer)-CPU, a DFP (i.e., Data Flow Processor), and a GSP (i.e., Graph Streaming Processor). The processor 6b may be at least one of a digital circuit and an analog circuit. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include the memory 6a in which a program is stored.

The control unit 6 implements angle-measuring processing by processing multiple beat signals output from the receiver circuits 4. The angle-measuring processing is a process of calculating an angle of a reflected object relative to the radar device 1. The radar device 1 has a relatively high angular resolution by pseudo-ensuring the number of reception antennas RX in the MIMO system to be greater than or equal to the actual number of reception antennas. The control unit 6 executes a compensation process to compensate for a phase difference and an amplitude difference of the signals occurring between different transmission circuits 3 and different receiver circuits 4, thereby ensuring a relatively high angle measurement accuracy.

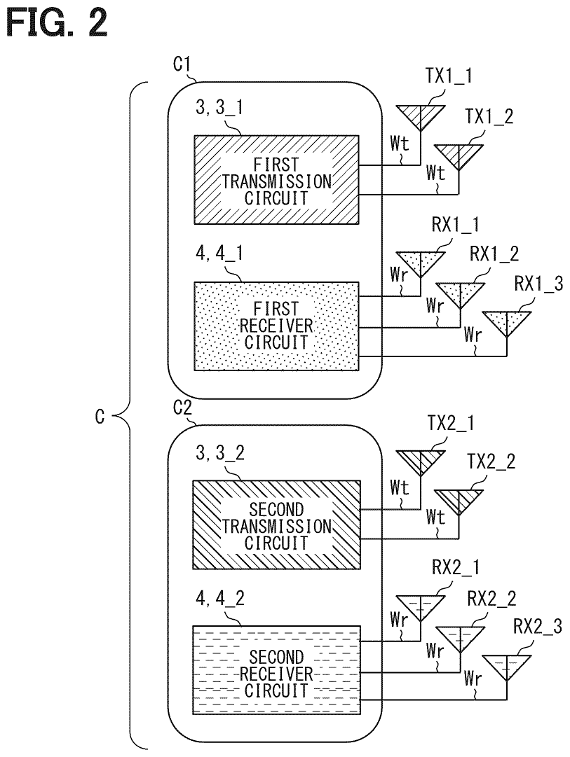

For the compensation process described above, each transmission antenna TX and each reception antenna RX is arranged in a prescribed arrangement. An arrangement of the transmission antennas TX and the reception antennas RX will be described below with reference to specific examples shown in FIGS. 2 to 4.

With multiple transmission antennas TX and multiple reception antennas RX, multiple virtual antennas V corresponding to the phase differences of the received signals between the reception antennas RX are assumed for each transmission antenna TX. A virtual position of each virtual antenna V is defined by a relative position of its corresponding transmission antenna TX with respect to the other transmission antennas TX and a relative position of its corresponding reception antenna RX with respect to the other reception antennas RX.

First, a set of pairs of virtual antennas whose virtual positions overlap and whose combinations of transmission circuit 3 and receiver circuit 4 do not match is extracted from the groups of virtual antennas V assumed for each transmit antenna TX. Next, the transmission antenna TX and the reception antenna RX are arranged in such a way that the number of unique pairs in this set, which are pairs of virtual antennas V whose combinations of transmission circuit 3 and the receiver circuit 4 do not overlap with other pairs, is at least Ns+Nr−2 pairs.

As an example, the radar device 1 having four transmission antennas TX and six reception antennas RX is assumed. Furthermore, in this example, it is assumed that the number of transmission circuits 3 is Ns=2, and the number of receiver circuits 4 is Nr=2. In this case, as shown in FIG. 2, the number of channels in one transmission circuit 3 is at least two, and the number of channels in one receiver circuit 4 is at least three. In the following, one of the transmission circuits 3 is referred to as a first transmission circuit 3_1, and the other is referred to as a second transmission circuit 3_2. Moreover, one of the receiver circuits 4 is referred to as a first receiver circuit 4_1, and the other is referred to as a second receiver circuit 4_2. In the present embodiment, the receiver circuits 4 and the transmission circuits 3 are mounted on circuit chips C. More specifically, the first transmission circuit 3_1 and the first receiver circuit 4_1 are mounted on the same first circuit chip C1. The second transmission circuit 3_2 and the second receiver circuit 4_2 are mounted on the same second circuit chip C2. It is assumed that wiring lengths of wirings Wt between the transmission antennas TX and the corresponding transmission circuits 3 are all substantially the same. Also, it is assumed that wiring lengths of wirings Wr between the reception antennas RX and the corresponding receiver circuits 4 are all substantially the same.

Furthermore, in the following description, four transmission antennas TX and six reception antennas RX may be distinguished by assigning different reference numerals to each of them. More specifically, the two transmission antennas TX connected to the first transmission circuit 3_1 are referred to as transmission antennas TX1_1 and TX1_2, and the two transmission antennas TX connected to the second transmission circuit 3_2 are referred to as transmission antennas TX2_1 and TX2_2. The three reception antennas RX connected to the first receiver circuit 4_1 are reception antennas RX1_1, RX1_2, and RX1_3, and the three reception antennas RX connected to the second receiver circuit 4_2 are reception antennas RX2_1, RX2_2, and RX2_3.

In this case, the transmission antenna TX and the reception antenna RX are arranged so that the number of pairs of the transmission circuit 3 and the receiver circuit 4 that do not overlap with other pairs in the above-mentioned group of virtual antennas V is at least Ns+Nr−2 pairs, i.e., 2 pairs. In the present embodiment, the transmission antennas TX and the reception antennas RX are arranged one-dimensionally. Here, one-dimensional alignment means alignment along a reference direction.

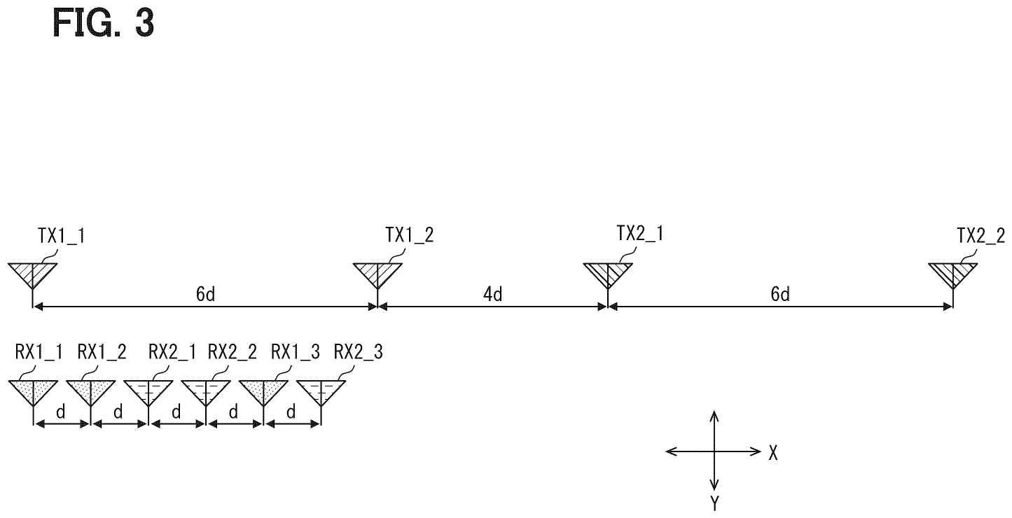

In an example shown in FIG. 3, the transmission antennas TX1_1, TX1_2, TX2_1, and TX2_2 are arranged in this order from one side to the other in an X-direction, which is the reference direction. The transmission antenna TX1_1 and the transmission antenna TX1_2 are arranged with an interval 6d therebetween. The transmission antenna TX1_2 and the transmission antenna TX2_1 are arranged with an interval 4d therebetween. The transmission antenna TX2_1 and the transmission antenna TX2_2 are arranged with an interval 6d therebetween.

Furthermore, the reception antennas RX1_1, RX1_2, RX2_1, RX2_2, RX2_3, and RX1_3 are arranged in this order from one side to the other in the reference direction at an interval d.

The number of virtual antennas V is assumed to be six, that is, the number of reception antennas RX, for each of the transmission antennas TX1_1, TX1_2, TX2_1, and TX2_2. Therefore, a total of 24 virtual antennas V are assumed.

Here, the virtual antennas V assumed for the transmission antenna TX1_1 are, from one side to the other, virtual antennas V1, V2, V3, V4, V5, and V6. The virtual antennas V assumed for the transmission antenna TX1_2 are, from one side to the other, virtual antennas V7, V8, V9, V10, V11, and V12. A group of virtual antennas V assumed for the transmission antenna TX2_1 is, from one side to the other, virtual antennas V13, V14, V15, V16, V17, and V18. A group of virtual antennas V assumed for the transmission antenna TX2_2 is, from one side to the other, virtual antennas V19, V20, V21, V22, V23, and V24.

Since the transmission antenna TX1_1 and the transmission antenna TX1_2 are arranged with the interval 6d between them, the multiple virtual antennas V assumed for the transmission antenna TX1_1 are at virtual positions that are shifted by 6d relative to the multiple virtual antennas V assumed for the transmission antenna TX1_2. Since the transmission antenna TX1_1 and the transmission antenna TX2_1 are arranged with the interval 4d between them, the multiple virtual antennas V assumed for the transmission antenna TX1_2 are at virtual positions that are shifted by 4d relative to the multiple virtual antennas V assumed for the transmission antenna TX2_1. Since the transmission antenna TX2_1 and the transmission antenna TX2_2 are arranged with the interval 6d between them, the multiple virtual antennas V assumed for the transmission antenna TX2_1 are at virtual positions that are shifted by 6d relative to the multiple virtual antennas V assumed for the transmission antenna TX2_2.

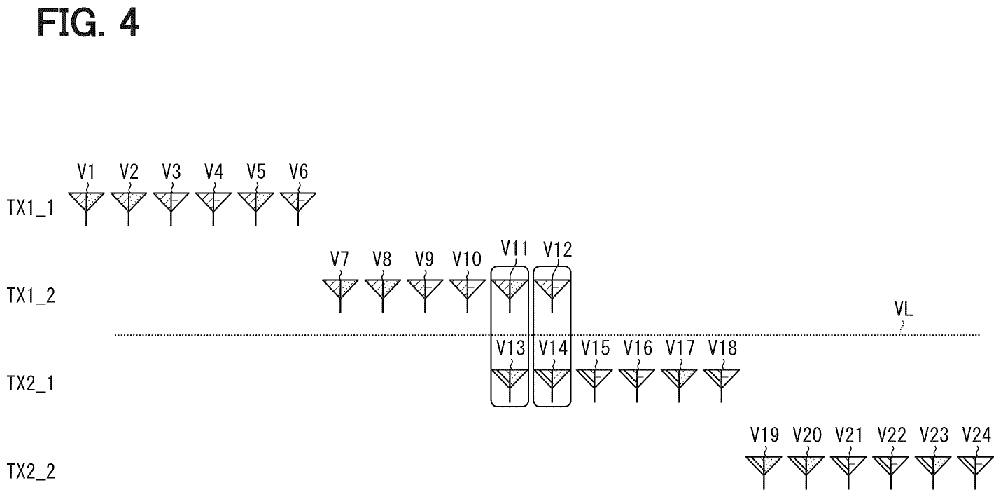

Therefore, in such an arrangement of the antennas TX, RX, there are two sets of virtual antennas V whose virtual positions overlap, as shown in FIG. 4. In FIG. 4, for ease of viewing, the virtual positions of the multiple virtual antennas V for each transmission antenna TX are shifted in an up-down direction on a page. In reality, the virtual positions of the multiple virtual antennas V are assumed to be on a virtual line VL extending in the reference direction (X-direction). That is, in FIG. 4, the virtual antennas V that are at the same left-right position on the paper form a pair of virtual antennas V whose virtual positions overlap.

In the following, a specific set of virtual antennas V whose virtual positions overlap will be expressed as (Vn, Vm) using the reference numerals given to each individual virtual antenna V (“n” and “m” are natural numbers). More specifically, (V11, V13) and (V12, V14) are pairs of virtual antennas V whose virtual positions overlap.

The above-mentioned sets constitute a set of sets in which the combinations of the transmission circuits 3 and the receiver circuits 4 do not overlap among the virtual antennas V. Furthermore, these two sets are sets in which the combinations of the transmission circuits 3 and the receiver circuits 4 do not overlap with each other. Therefore, the number of pairs of transmission circuits 3 and receiver circuits 4 that do not overlap with other pairs is two, which satisfies the condition of at least Ns+Nr−2 pairs.

Furthermore, when at least Ns+Nr−2 pairs of virtual antennas V whose combinations of the transmission circuits 3 and the receiver circuits 4 do not overlap with other pairs are secured, the control unit 6 may additionally consider pairs whose combinations of the transmission circuits 3 and the receiver circuits 4 overlap with those pairs as pairs to be used for compensation processing.

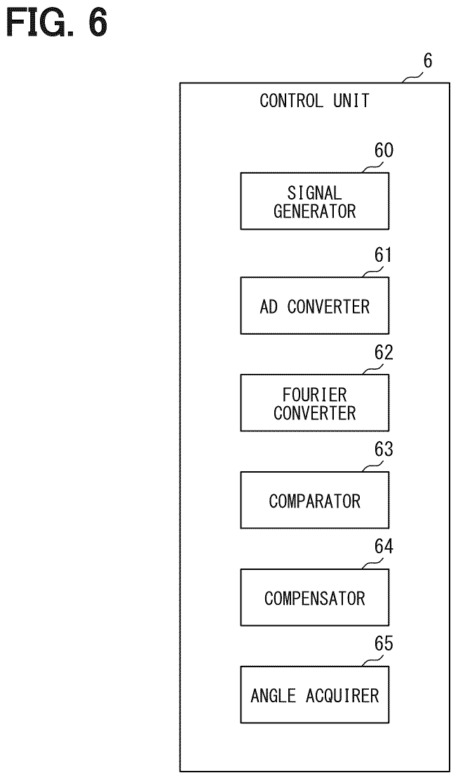

To control the radar device 1, including the compensation process described above, the processor 6b executes instructions contained in a control program stored in the memory 6a. In this way, the control unit 6 establishes a functional unit for controlling the radar device 1. More specifically, as shown in FIG. 6, the control unit 6 includes a signal generator 60, an AD converter 61, a Fourier converter 62, a comparator 63, a compensator 64, and an angle acquirer 65 as functional units.

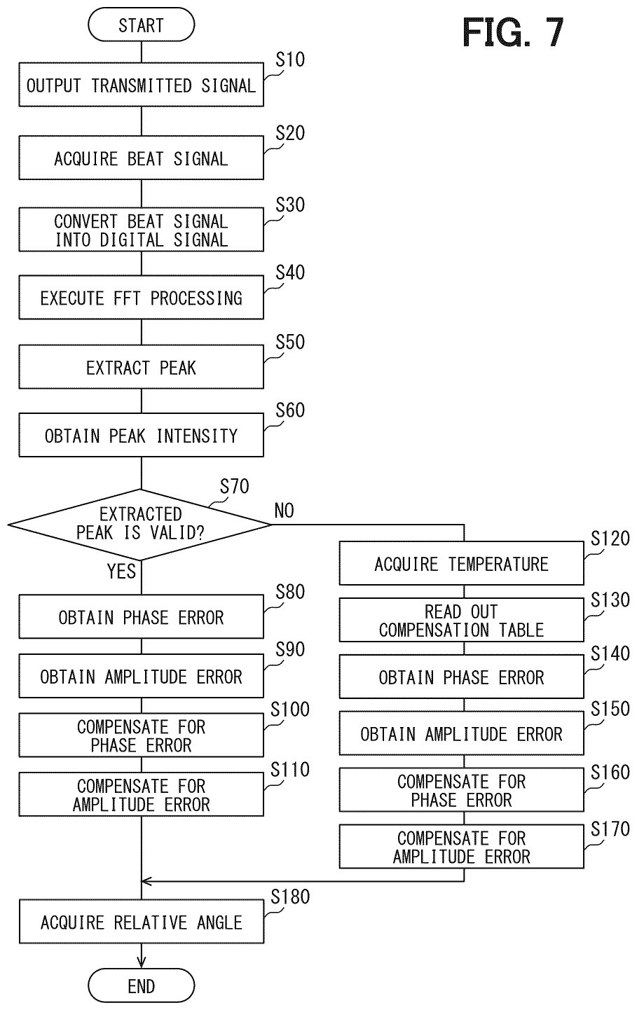

A radar control method in which the control unit 6 controls the radar device 1 by using such functions of the processor 6b is executed according to a control flow shown in FIG. 7. This control flow is repeatedly executed during power on state of the vehicle. Here, in this flow, “S” means steps of the process executed by instructions included in the control program.

First, in S10, the signal generator 60 causes the oscillator 2 to output a transmitted signal. In the next step S20, the AD converter 61 acquires, from the receiver circuit 4, a beat signal corresponding to a received signal that is a result of the transmitted signal transmitted from the transmission antenna TX to the external environment being reflected by a target and received by the reception antenna RX. In S30, the AD converter 61 converts the beat signal into a digital signal through A/D conversion processing in which the beat signal is sampled at a predetermined time interval. In the next step S40, the Fourier converter 62 executes FFT (Fast Fourier Transform) processing for each chirp of the A/D converted beat signal. As a result, the Fourier converter 62 obtains, for each chirp, a frequency spectrum (distance spectrum) that shows a peak at a frequency position corresponding to a distance to the target. The distance spectrum is data indicating the signal strength for each distance bin according to the distance resolution.

Then, the Fourier converter 62 performs an FFT process on the distance spectrum. That is, the Fourier converter 62 performs a second FFT process on a waveform in which phases at the distance bins obtained in the first FFT process for the multiple chirps are arranged in time series. As a result, it is possible to obtain, for each velocity bin, a frequency spectrum (velocity spectrum) that shows a peak at a position corresponding to the relative velocity with respect to the target. By the above two-dimensional FFT, the Fourier converter 62 acquires two-dimensional information (RV map) that indicates peaks at positions according to the distance to the target and the relative velocity of the target.

Next, in S50, the comparator 63 extracts a peak from the RV map. In the next step S60, the comparator 63 obtains the intensity of the extracted peak. Then, in S70, the comparator 63 determines whether the extracted peak is valid. For example, when the intensity of a peak is within the allowable intensity range, the comparator 63 determines that the peak is valid. Here, the acceptable intensity range is a range in which the intensity is equal to or greater than a predetermined threshold. When it is determined that a valid peak exists, the flow proceeds to S80.

In S80, the compensator 64 obtains a phase error between the transmission circuit 3 and the receiver circuit 4 based on the phase of the effective peak in each virtual channel.

In a phase compensation process, the compensator 64 defines a linear equation based on the phase difference of the peaks in the beat signal for each of Ns+Nr−2 or more pairs of virtual antennas V whose combinations of the transmission circuits 3 and the receiver circuits 4 do not overlap with other pairs. This linear equation is defined with a relative phase error between the transmission circuit 3 and the receiver circuit 4 as an unknown. The compensator 64 obtains a solution of this linear equation as the relative phase error. Since the beat signal is a signal related to the received signal, the phase difference of the peaks in the beat signal is an example of a comparison result of the received signals between virtual antennas V.

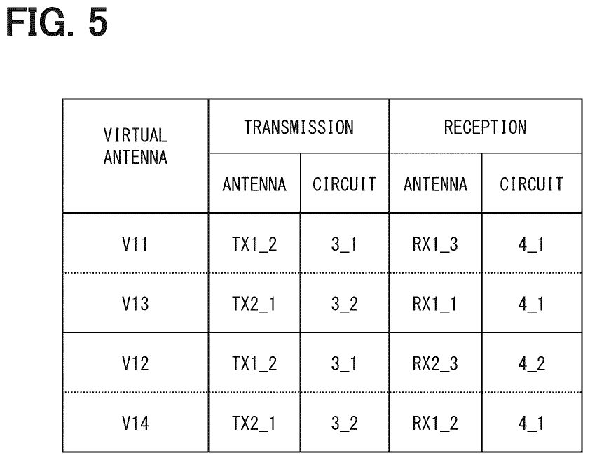

An acquisition of the relative phase error is described in detail below. In the following description, the phase at the peak of the beat signal corresponding to the virtual antenna Vn will be represented as θ_{Vn} (“n” is a natural number). In the following explanation, for simplicity, only two pairs, (V11, V13) and (V12, V14), as shown in FIG. 5, will be used as pairs in which the combination of the transmission circuit 3 and the receiver circuit 4 does not overlap with other pairs.

In this case, the peak phase difference θ_{V11}−θ_{V13} for (V11, V13) can be defined by a relationship shown in equation (1), and the peak phase difference θ_{V12}−θ_{V14} for (V12, V14) can be defined by a relationship shown in equation (2).

$$( Math 1 )$$

$${θ}_{V 11} - {θ}_{V 13} = ( {Θ}_{a} + {e}_{tx 1} + {e}_{rx 1} ) - ( {Θ}_{a} + {e}_{tx 2} + {e}_{rx 1} ) \qquad ( 1 )$$

$$( Math 2 )$$

$${θ}_{V 12} - {θ}_{V 14} = ( {Θ}_{b} + {e}_{tx 1} + {e}_{rx 2} ) - ( {Θ}_{b} + {e}_{tx 2} + {e}_{rx 1} ) \qquad ( 2 )$$

In the above equations, “Θₐ”, and “Θ_{b}” are phase errors caused by the target. Furthermore, “eₜₓ₁” is a phase error of the signal generated in the first transmission circuit 3_1, and “eₜₓ₂” is a phase error of the signal generated in the second transmission circuit 3_2. A phase error “eᵣₓ₁” is a phase error of the signal generated in the first receiver circuit 4_1, and “eᵣₓ₂” is a phase error of the signal generated in the second receiver circuit 4_2.

Here, in the phase compensation, a relative phase error between the transmission circuits 3 and a relative phase error between the receiver circuits 4 need only be taken into consideration. Therefore, when taking into consideration the relative phase error of the second transmission circuit 3_2 with respect to the first transmission circuit 3_1 and the relative phase error of the second receiver circuit 4_2 with respect to the first receiver circuit 4_1, then eₜₓ₁ and eᵣₓ₁ can be set to 0. Therefore, equations (1), (2) can be transformed into the following equations (3), (4).

$$( Math 3 )$$

$${θ}_{V 11} - {θ}_{V 13} = - {e}_{tx 2} \qquad ( 3 )$$

$$( Math 4 )$$

$${θ}_{V 12} - {θ}_{V 14} = - {e}_{tx 2} + {e}_{rx 2} \qquad ( 4 )$$

When equations (3), (4) are converted into a matrix format, the phase difference and the relative phase error of each pair satisfy a relationship expressed by the following equation (5).

$$( Math 5 )$$

$$( \begin{matrix}{θ}_{V 11} - {θ}_{V 13} \\ {θ}_{V 12} - {θ}_{V 14}\end{matrix} ) = ( \begin{matrix}- 1 & 0 \\ - 1 & 1\end{matrix} ) \cdot ( \begin{matrix}{e}_{tx 2} \\ {e}_{rx 2}\end{matrix} ) \qquad ( 5 )$$

Here, a term on a left side of equation (5) is a phase difference vector Y1 between the overlapping virtual antennas V. A first term on a right side of equation (5) is a coefficient matrix A1, and a second term is a phase error vector X1. In equation (5), the phase difference vector Y1 can be calculated from the phase of the peak in each beat signal. The coefficient matrix A1 is a constant matrix defined by the combination of the transmission circuit 3 and the receiver circuit 4 of each set of the virtual antenna V. Therefore, equation (5) can be solved as a simultaneous equation with eₜₓ₂ and eᵣₓ₂ as unknowns. That is, the compensator obtains eₜₓ₂ and eᵣₓ₂ as the solution of equation (5) as the relative phase error of the second transmission circuit 3_2 with respect to the first transmission circuit 3_1 and the relative phase error of the second receiver circuit 4_2 with respect to the first receiver circuit 4_1.

In the next step S90, the compensator 64 obtains an amplitude error between the transmission circuit 3 and the receiver circuit 4 based on an amplitude of the effective peak in each virtual antenna V.

In the amplitude compensation process, similarly to the phase compensation process, the compensator 64 defines a linear equation for each unique pair based on the amplitude difference of the peaks of the beat signals, with the amplitude error between the transmission circuit 3 and the receiver circuit 4 as unknowns. The compensator 64 obtains a solution of this linear equation as the relative amplitude error. The amplitude difference between the peaks in the beat signal is an example of a comparison result of the received signals from the virtual antennas V.

In the following description, it is assumed that the same set of virtual antennas V as in the above-mentioned phase compensation process is also used in the amplitude compensation process. In the following description, the amplitude at the peak of the beat signal corresponding to a virtual antenna Vn will be represented as A_{Vn} (n is a natural number). In this case, a peak amplitude difference A_{V11}−A_{V13} for (V11, V13) can be defined by a relationship shown in equation (6), and a peak amplitude difference A_{V12}−A_{V14} for (V12, V14) can be defined by a relationship shown in equation (7).

$$( Math 6 )$$

$${A}_{V 11} - {A}_{V 13} = ( {G}_{a} + {G}_{tx 1} + {G}_{rx 1} ) - ( {G}_{a} + {G}_{tx 2} + {G}_{rx 1} ) \qquad ( 6 )$$

$$( Math 7 )$$

$${A}_{V 12} - {A}_{V 14} = ( {G}_{b} + {G}_{tx 1} + {G}_{rx 2} ) - ( {G}_{b} + {G}_{tx 2} + {G}_{rx 1} ) \qquad ( 7 )$$

In the above equation, Gₐ, and G_{b} are amplitude errors caused by the target. Furthermore, “Gₜₓ₁” is an amplitude error of the signal generated in the first transmission circuit 3_1, and “Gₜₓ₂” is an amplitude error of the signal generated in the second transmission circuit 3_2. An amplitude error “Gᵣₓ₁” is an amplitude error of the signal generated in the first receiver circuit 4_1, and “Gᵣₓ₂” is an amplitude error of the signal generated in the second receiver circuit 4_2.

Here, similarly to the phase compensation, when the relative amplitude error of the second transmission circuit 3_2 with respect to the first transmission circuit 3_1 and the relative amplitude error of the second receiver circuit 4_2 with respect to the first receiver circuit 4_1 are taken into consideration, then Gₜₓ₁, Gᵣₓ₁ can be set to 0. Therefore, equations (6), (7) can be transformed into the following equations (8), (9).

$$( Math 8 )$$

$${A}_{V 11} - {A}_{V 13} = - {G}_{tx 2} \qquad ( 8 )$$

$$( Math 9 )$$

$${A}_{V 12} - {A}_{V 14} = - {G}_{tx 2} + {G}_{rx 2} \qquad ( 9 )$$

When equations (8), (9) are converted into a matrix format, the amplitude difference and the relative amplitude error of each pair satisfy the relationship expressed by a following equation (10).

$$( Math 10 )$$

$$( \begin{matrix}{A}_{V 11} - {A}_{V 13} \\ {A}_{V 12} - {A}_{V 14}\end{matrix} ) = ( \begin{matrix}- 1 & 0 \\ - 1 & 1\end{matrix} ) \cdot ( \begin{matrix}{G}_{tx 2} \\ {G}_{rx 2}\end{matrix} ) \qquad ( 10 )$$

Here, a term on a left side of equation (10) is an amplitude difference vector Y2 between the overlapping virtual antennas V. A first term on a right side of equation (10) is a coefficient matrix A2, and a second term is an amplitude error vector X2. The amplitude difference vector Y2 can be calculated from the peak amplitude of each beat signal. The coefficient matrix A1 is a constant matrix defined by the combination of the transmission circuit 3 and the receiver circuit 4 of each set of the virtual antenna V. That is, the compensator 64 obtains Gₜₓ₂ and Gᵣₓ₂ as the solutions of equation (10) as the relative amplitude error of the second transmission circuit 3_2 with respect to the first transmission circuit 3_1 and the relative amplitude error of the second receiver circuit 4_2 with respect to the first receiver circuit 4_1.

Then, in S100, the compensator 64 compensates for the phase error between the transmission circuit 3 and the receiver circuit 4. For example, the compensator 64 stores the acquired relative phase error in the memory 6a as compensation data to be used when acquiring a relative angle, which will be described later. Furthermore, in S110, the compensator 64 compensates for the relative amplitude error between the transmission circuit 3 and the receiver circuit 4 by storing the error as compensation data in the memory 6a.

On the other hand, when it is determined in S70 that the valid peak does not exist, the flow proceeds to S120. In S120, the compensator 64 acquires temperature of the transmission circuits 3 and the receiver circuits 4 from the temperature sensors 5. Then, in S130, the compensator 64 reads out from the memory 6a a compensation table for the phase error and the amplitude error between the transmission circuits 3 according to temperature.

Next, in S140, the compensator 64 obtains the relative phase error between the transmission circuit 3 and the receiver circuit 4 by comparing the obtained temperature with the correction table. Then, in S150, the compensator 64 obtains the relative amplitude error between the transmission circuits 3 and the receiver circuits 4 by comparing the obtained temperature with the correction table. Then, in S160, the compensator 64 compensates for the relative phase error between the transmission circuits 3 and the receiver circuits 4. Furthermore, in S170, the compensator 64 compensates for the relative amplitude error between the transmission circuits 3 and the receiver circuits 4.

In S180 following S110 or S170, the angle acquirer 65 acquires the relative angle of the target. More specifically, the angle acquirer 65 acquires the phase difference between the virtual antennas V by performing the FFT processing on multiple peaks extracted from the beat signal based on the received signal of each virtual antenna V after compensation. Since the phase difference between the virtual antennas V is related to the relative angle of the target, the angle acquirer 65 acquires the relative angle by converting the acquired phase difference into the relative angle.

According to the first embodiment, at least one of the phase difference and the amplitude difference between different transmission circuits 3 and at least one of the phase difference and the amplitude difference between different receiver circuits 4 can be compensated for based on the comparison result between the received signals of the virtual antennas V in at least Ns+Nr−2 unique sets. Therefore, the error compensation processing can be performed not only between different receiver circuits 4 but also between different transmission circuits 3. Furthermore, by arranging at least one of the transmission antennas TX and the reception antennas RX at uneven intervals, an aperture length of the virtual antenna can be made larger than in a case where the antennas are arranged at equal intervals. More specifically, in the present embodiment, the transmission antennas TX are arranged at unequally spaced intervals 4d and 6d, so that the aperture length is larger than when the transmission antennas TX are arranged at equal intervals at the smaller interval 4d. The aperture length here is a distance from one end to the other end of the virtual antenna V, and is a distance from the virtual antenna V1 to the virtual antenna V24 shown in FIG. 4. In the present embodiment, the aperture length is 21*d. Therefore, both compensation accuracy and spatial resolution can be achieved.

### Second Embodiment

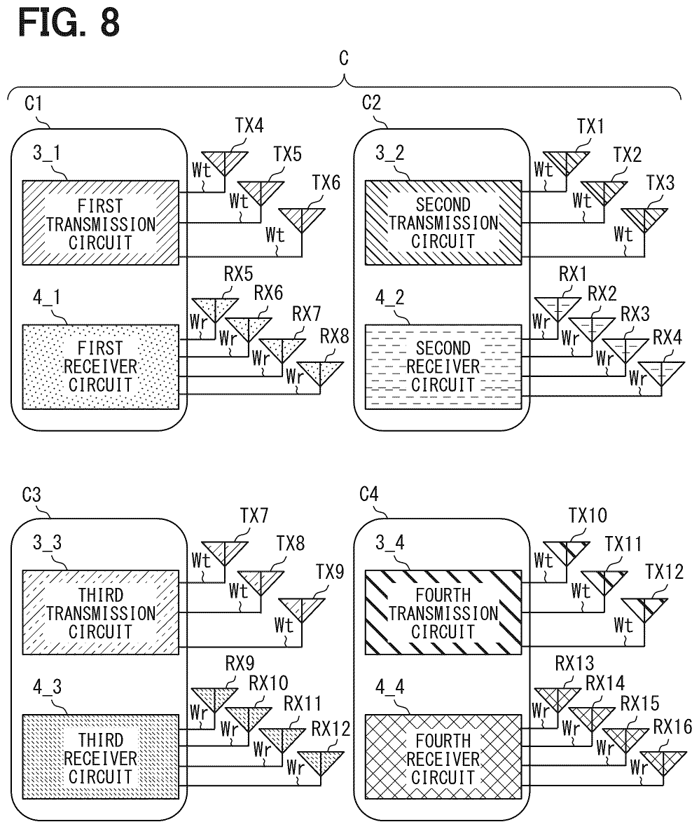

A second embodiment shown in FIGS. 8 to 11 is a modification of the first embodiment. In the second embodiment, transmission antennas TX and reception antennas RX are arranged two-dimensionally.

As an example, a radar device 1 having twelve transmission antennas TX and sixteen reception antennas RX is assumed. Furthermore, in this example, it is assumed that the number of transmission circuits 3 is Ns=4, and the number of receiver circuits 4 is Nr=4. In this case, as shown in FIG. 8, the number of channels in one transmission circuit 3 is at least three, and the number of channels in one receiver circuit 4 is at least four. In the following, the four transmission circuits 3 may be distinguished as a first transmission circuit 3_1, a second transmission circuit 3_2, a third transmission circuit 3_3, and a fourth transmission circuit 3_4. Furthermore, the four receiver circuits 4 may be distinguished as a first receiver circuit 4_1, a second receiver circuit 4_2, a third receiver circuit 4_3, and a fourth receiver circuit 4_4.

In the present embodiment, the receiver circuits 4 and the transmission circuits 3 are mounted on circuit chips C. More specifically, the first transmission circuit 3_1 and the first receiver circuit 4_1 are mounted on the same first circuit chip C1. The second transmission circuit 3_2 and the second receiver circuit 4_2 are mounted on the same second circuit chip C2. In addition, the third transmission circuit 3_3 and the third receiver circuit 4_3 are mounted on the same third circuit chip C3. The fourth transmission circuit 3_4 and the fourth receiver circuit 4_4 are mounted on the same second circuit chip C4. It is assumed that wiring lengths of wirings Wt between the transmission antennas TX and the corresponding transmission circuits 3 are all substantially the same. Also, it is assumed that wiring lengths of wirings Wr between the reception antennas RX and the corresponding receiver circuits 4 are all substantially the same.

Furthermore, in the following description, twelve transmission antennas TX and sixteen reception antennas RX may be distinguished by assigning different reference numerals to each of them. More specifically, the three transmission antennas TX connected to the first transmission circuit 3_1 are referred to as transmission antennas TX4, TX5 and TX6, and the three transmission antennas TX connected to the second transmission circuit 3_2 are referred to as transmission antennas TX1, TX2 and TX3. The three transmission antennas TX connected to the third transmission circuit 3_3 are referred to as transmission antennas TX7, TX8 and TX9, and the three transmission antennas TX connected to the fourth transmission circuit 3_4 are referred to as transmission antennas TX10, TX11 and TX12.

The four reception antennas RX connected to the first receiver circuit 4_1 are reception antennas RX5, RX6, RX7, and RX8, and the four reception antennas RX connected to the second receiver circuit 4_2 are reception antennas RX1, RX2, RX3, and RX4. The four reception antennas RX connected to the third receiver circuit 4_3 are reception antennas RX9, RX10, RX11, and RX12, and the four reception antennas RX connected to the fourth receiver circuit 4_4 are reception antennas RX13, RX14, RX15, and RX16.

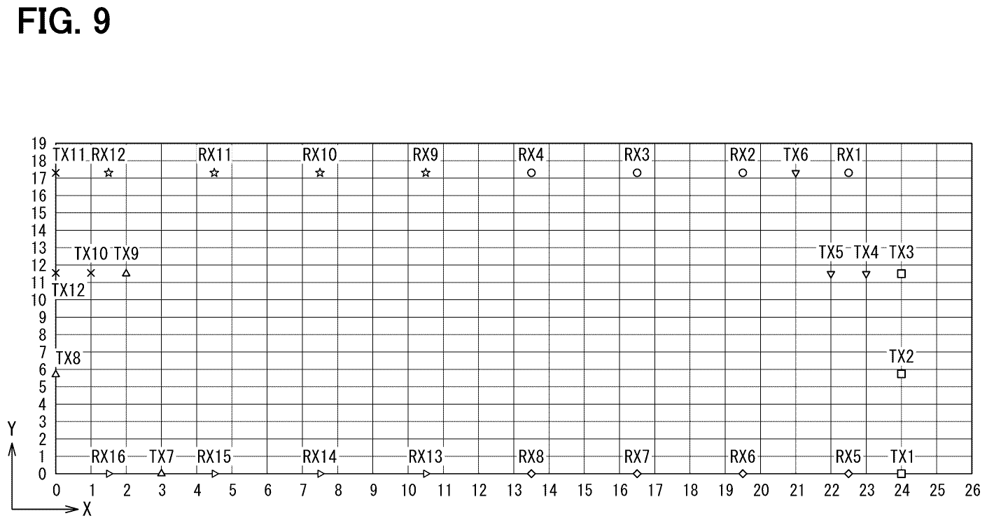

The transmission antennas TX and the reception antennas RX are arranged two-dimensionally. As shown in FIG. 9, four rows of the transmission antennas TX aligned in the X-direction are spaced apart in the Y-direction. Of the four rows aligned in the X-direction, two transmission antennas TX are arranged in each of the first, second, and fourth rows from an origin in FIG. 9. Furthermore, among the four rows aligned in the X-direction, six transmission antennas TX are arranged in the third row from the origin. Here, an interval between one scale division in the X-direction is set to an interval d, and an interval between one scale division in the Y-direction is set to an interval s. The transmission antennas TX12, TX10, TX9 are arranged at equal intervals d. In addition, the transmission antennas TX5, TX4, TX3 are also arranged at equal intervals d. On the other hand, the transmission antennas TX9, TX5 are arranged at a distance 20*d between them. That is, in this third row, the transmission antennas TX are arranged at uneven intervals in the X-direction.

Furthermore, two rows of the reception antennas RX aligned in the X-direction are arranged spaced apart in the Y-direction. In each of the two rows aligned in the X-direction, eight reception antennas TX are arranged. In each row, the reception antennas RX are arranged at equal intervals in the X-direction. Furthermore, of the two rows aligned in the X-direction, the first row from the origin is arranged so as to be aligned in the Y-direction at the same position as the first row from the origin in the transmission antenna TX. Of the two rows aligned in the X-direction, the second row from the origin is arranged so as to be aligned in the Y-direction with the fourth row from the origin on the transmission antenna TX.

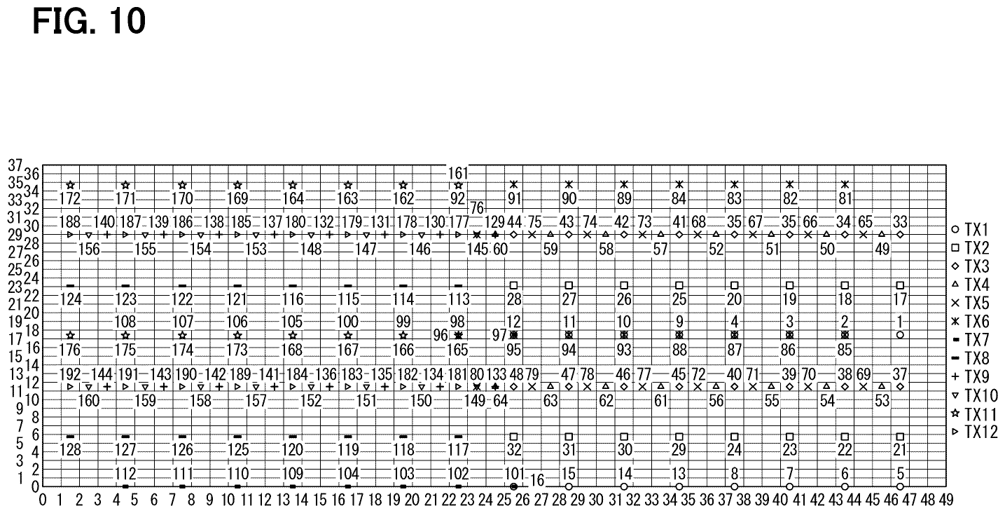

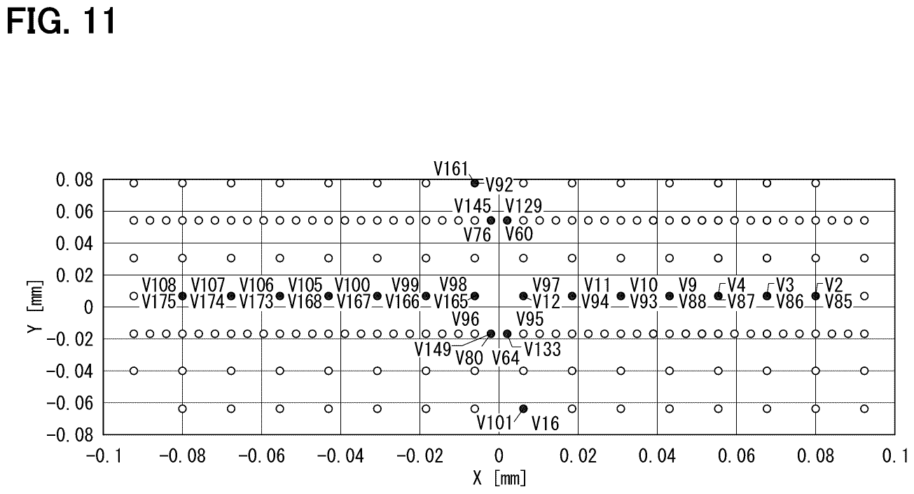

The virtual antennas V are assumed to be the same as the number of the reception antennas RX, that is, 16, for each of the twelve transmission antennas TX. Therefore, a total of 192 virtual antennas V are assumed. More specifically, 192 virtual antennas V are assumed to be arranged as shown in FIGS. 10, 11.

In the following, among the 16 virtual antennas V assumed for a specific transmission antenna TXa, a virtual antenna V corresponding to a specific reception antenna RXb (“a” and “b” are natural numbers) is denoted as Vc (c=(a−1)*16+b). In FIG. 10, the letter “V” is omitted to avoid complication.

As shown in FIGS. 10, 11, there are 24 pairs of virtual antennas V whose virtual positions overlap. Among these, there are 13 unique pairs in which a combination of the transmission circuit 3 and the receiver circuit 4 does not overlap with other pairs. For example, (V2, V85), (V9, V88), (V10, V93), (V12, V97), (V16, V86), (V60, V129), (V64, V133), (V76, V145), (V80, V149), (V95, V97), (V98, V165), (V105, V168), and (V106, V173) can be considered as unique pairs. A compensator 64, which will be described later, performs compensation processing based on received signals that can be acquired by each of at least six pairs of virtual antennas V from these pairs.

The pair of virtual antennas V assumed for the compensation process may be other than the above-mentioned sets, so long as the combination of the transmission circuit 3 and the receiver circuit 4 does not overlap with other sets. For example, (V3, V86) and (V4, V87) overlap with (V2, V85) in terms of combinations of the transmission circuit 3 and the receiver circuit 4, but do not overlap with other combinations. Therefore, assuming (V3, V86) or (V4, V87) as one of the 13 pairs is equivalent to assuming (V2, V85).

When the number of antennas TX, RX is relatively large as described above, the arrangement of the antennas TX, RX can be determined by a genetic algorithm. For example, characteristics used to evaluate a current generation produced by the genetic algorithm includes overlap efficiency, rank, wiring efficiency, FOV (Field of View), and separation angle. The overlap efficiency is a parameter obtained by dividing the full rank number by the number of channels reduced due to overlap of virtual positions, and it is desirable that the overlap efficiency is large. The rank is a predetermined parameter. The wiring efficiency is a parameter that corresponds to dispersion of antenna coordinates input to the same circuit, and it is desirable that the efficiency is small. The FOV is a parameter that depends on a distance between the antennas, and it is desirable that the FOV is small. The separation angle is a parameter that depends on the aperture length, and it is desirable that the separation angle is large.

### Third Embodiment

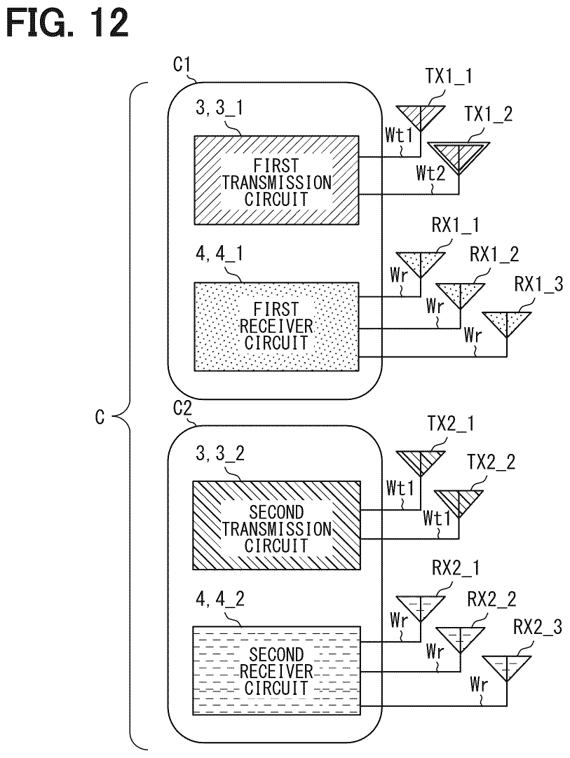

A third embodiment shown in FIGS. 12 to 16 is a modification of the first embodiment.

The numbers of transmission circuits 3 and receiver circuits 4, and the numbers of transmission antennas TX and reception antennas RX in the third embodiment are the same as those in the first embodiment. Therefore, in the following description, the individual circuits 3 and antennas TX, RX may be distinguished by being given the same reference numerals as in the first embodiment.

In the radar device 1 of the third embodiment, at least one transmission antenna TX has a wiring length different from the other transmission antennas TX. In an example shown in FIG. 11, it is assumed that a wire Wt2 of the transmission antenna TX1_2 connected to the first transmission circuit 3_1 has a longer wiring length than a wire Wt1 of the other transmission antenna TX. Also, it is assumed that the wiring lengths of the wires Wr of the reception antenna RX are all substantially the same.

When antennas having different wiring lengths are present, first, a set of pairs of virtual antennas whose virtual positions overlap and whose combinations of the transmission circuit 3 and the receiver circuit 4 do not match among the group of virtual antennas V assumed for each transmit antenna TX is extracted. When antennas with different wiring lengths exist, the transmission antenna TX and the reception antenna RX are arranged in such a way that the number of unique pairs of virtual antennas V whose combinations of the transmission circuit 3 and the receiver circuit 4 do not overlap with other pairs in the extracted set of pairs is at least Ns+Nr−2 pairs.

In addition, the transmission antennas TX and the reception antennas RX are arranged so as to include at least one different wiring length pair, which is a pair of virtual antennas whose virtual positions overlap and whose wiring lengths do not match. Furthermore, the transmission antennas TX and the reception antennas RX are arranged so that the total number of groups, which are groups of virtual antennas V belonging to at least one of the above-mentioned unique group and different wiring length group, is at least Ns+Nr−1 groups.

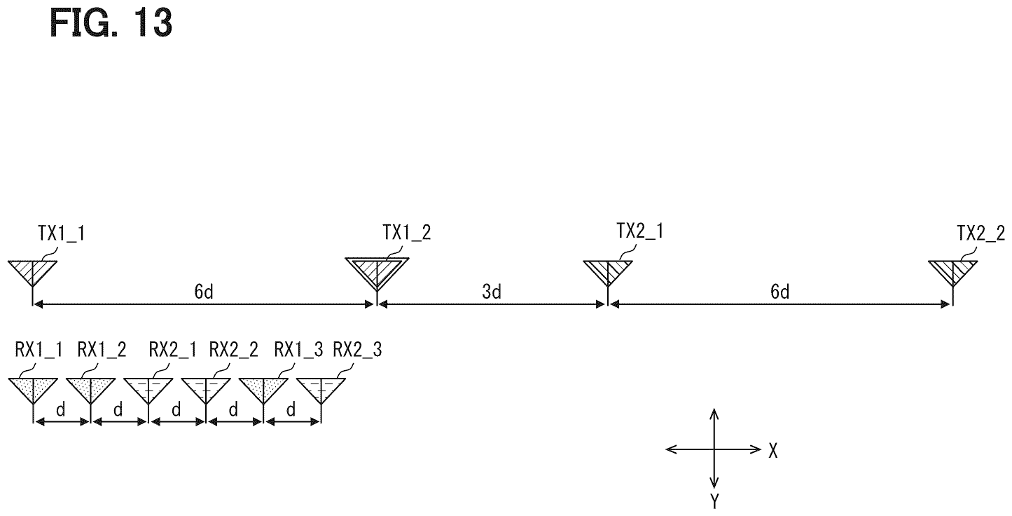

In an example shown in FIG. 13, the transmission antennas TX1_1, TX1_2, TX2_1, and TX2_2 are arranged in this order from one side to the other in the X-direction. The transmission antenna TX1_1 and the transmission antenna TX1_2 are arranged with an interval 6d therebetween. The transmission antenna TX1_2 and the transmission antenna TX2_1 are arranged with an interval 3d therebetween. The transmission antenna TX2_1 and the transmission antenna TX2_2 are arranged with an interval 6d therebetween.

Furthermore, the reception antennas RX1_1, RX1_2, RX2_1, RX2_2, RX2_3, and RX1_3 are arranged in this order from one side to the other in the reference direction at an interval d.

The number of virtual antennas V is assumed to be six, that is, the number of reception antennas RX, for each of the transmission antennas TX1_1, TX1_2, TX2_1, and TX2_2. Therefore, a total of 24 virtual antennas V are assumed.

Here, the virtual antennas V assumed for the transmission antenna TX1_1 are, from one side to the other, virtual antennas V1, V2, V3, V4, V5, and V6. The virtual antennas V assumed for the transmission antenna TX1_2 are, from one side to the other, virtual antennas V7, V8, V9, V10, V11, and V12. A group of virtual antennas V assumed for the transmission antenna TX2_1 is, from one side to the other, virtual antennas V13, V14, V15, V16, V17, and V18. A group of virtual antennas V assumed for the transmission antenna TX2_2 is, from one side to the other, virtual antennas V19, V20, V21, V22, V23, and V24.

Since the transmission antenna TX1_1 and the transmission antenna TX1_2 are arranged with the interval 6d between them, the multiple virtual antennas V assumed for the transmission antenna TX1_1 are at virtual positions that are shifted by 6d relative to the multiple virtual antennas V assumed for the transmission antenna TX1_2. Since the transmission antenna TX1_1 and the transmission antenna TX2_1 are arranged with the interval 3d between them, the multiple virtual antennas V assumed for the transmission antenna TX1_2 are at virtual positions that are shifted by 3d relative to the multiple virtual antennas V assumed for the transmission antenna TX2_1. Since the transmission antenna TX2_1 and the transmission antenna TX2_2 are arranged with the interval 6d between them, the multiple virtual antennas V assumed for the transmission antenna TX2_1 are at virtual positions that are shifted by 6d relative to the multiple virtual antennas V assumed for the transmission antenna TX2_2.

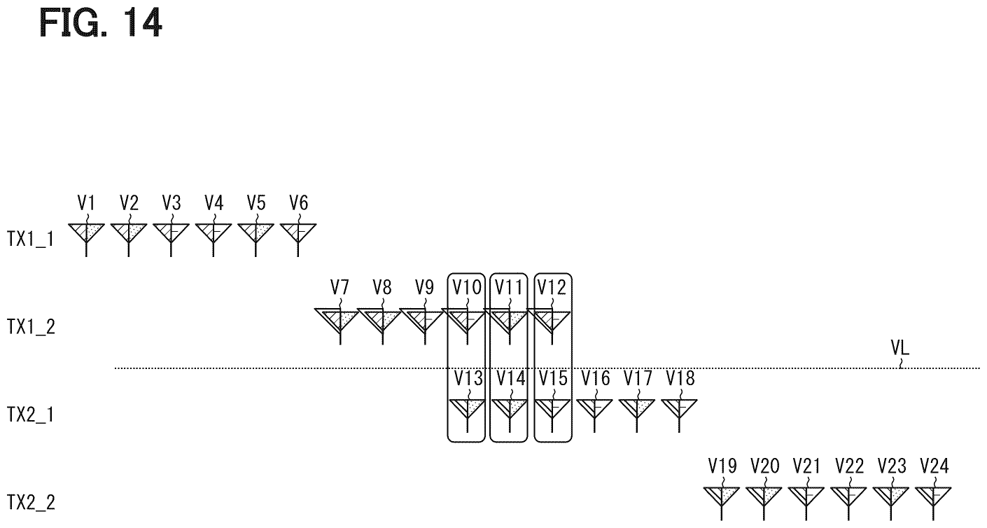

Therefore, in such an arrangement of the antennas TX, RX, there are three pairs of virtual antennas V whose virtual positions overlap, as shown in FIG. 14. More specifically, (V10, V13), (V11, V14), and (V12, V15) are pairs of virtual antennas V whose virtual positions overlap.

The above-mentioned three pairs constitute a group of sets in which the combinations of the transmission circuits 3 and the receiver circuits 4 do not overlap among the virtual antennas V. Furthermore, these three pairs are pairs in which the combinations of the transmission circuits 3 and the receiver circuits 4 do not overlap with each other. Therefore, in this antenna arrangement, the number of unique sets is three, which satisfies the condition of at least Ns+Nr−2 sets.

Furthermore, these three sets is different wiring length pairs. That is, the wiring lengths of the virtual antennas V10, V11, V12 are longer than the wiring lengths of the virtual antennas V13, V14, V15. Therefore, in this antenna arrangement, the number of different wiring length pair is three, which satisfies the condition of at least one pair. Furthermore, as a result of the above, the number of groups belonging to this antenna arrangement is three, which satisfies the condition of at least Ns+Nr−1 pairs.

In this case, the control unit 6 further calculates a phase error and an amplitude error according to the wiring length difference of the virtual antenna V in the processes of S80 and S90. Here, the wiring length of the virtual antenna V means the sum of a wiring length from the transmission antenna TX corresponding to the virtual antenna V to the transmission circuit 3 and a wiring length from the corresponding reception antenna RX to the receiver circuit 4. Here, only the wire Wt2 is longer than the wire Wt1, and all wire Wr of the reception antenna RX are substantially the same length, so the wiring length of the virtual antenna V assumed for the transmission antenna TX1_2 is longer than the wiring length of the virtual antenna V assumed for the transmission antennas TX other than the transmission antenna TX1_2.

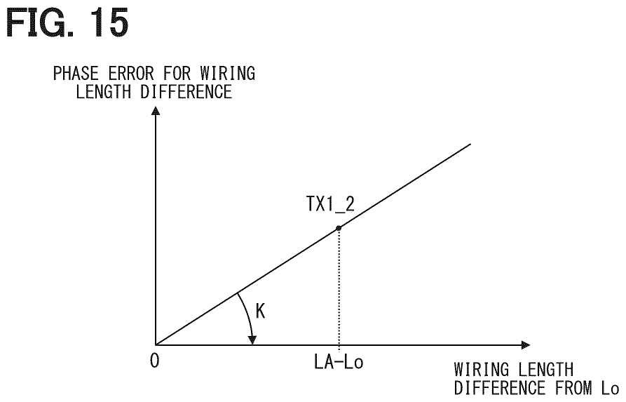

In general, the phase error due to the wiring length difference for each virtual antenna V increases linearly according to the wiring length difference from a reference wiring length Lo (for example, a shortest wiring length) as shown in FIG. 15. That is, the phase error for the wiring length difference is a value obtained by multiplying a gradient K by the wiring length difference. Here, the gradient K, which is related to a magnitude of the phase error relative to the wiring length difference, is a temperature parameter that changes depending on the temperature. That is, when the wiring length of the virtual antenna V assumed for the transmission antenna TX1_2 in the present embodiment is a wiring length LA, the gradient K can be calculated from the wiring length difference LA−Lo. In this case, the reference wiring length Lo is the wiring length of the virtual antenna V assumed for the transmission antenna TX other than the transmission antenna TX1_2.

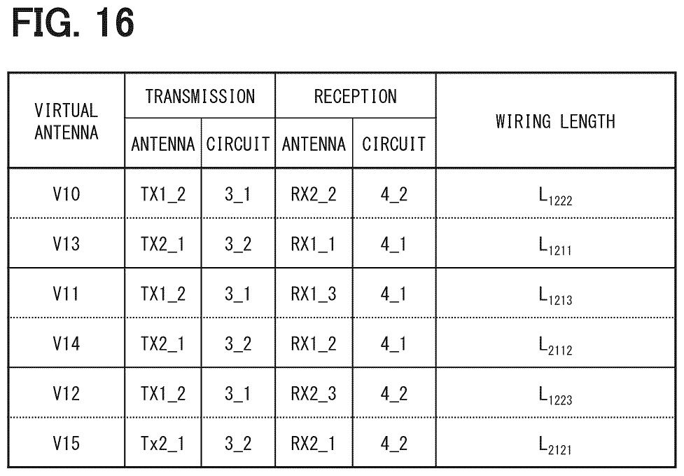

Here, the wiring length difference in a virtual antenna V assumed for a pair of a transmission antenna TXa_b and a reception antenna RXc_d is represented as L_{abcd} (a, b, c, and d are natural numbers). The compensator 64 uses the three sets (V10, V13), (V11, V14), (V12, V15) as the groups it belongs to, as described above. When the phase error due to the wiring length difference L_{abcd} is denoted by e_{abcd}, in an example shown in FIG. 16, the peak phase difference θ_{V10}−θ_{V13} for (V10, V13) can be defined by a relationship shown in equation (11), the peak phase difference θ_{V11}−θ_{V14} for (V11, V14) can be defined by a relationship shown in equation (12), and the peak phase difference θ_{V12}−θ_{V15} for (V12, V15) can be defined by a relationship shown in equation (13).

$$( Math 11 )$$

$${θ}_{V 10} - {θ}_{V 13} = ( {Θ}_{a} + {e}_{tx 1} + {e}_{rx 2} + {e}_{1222} ) - ( {Θ}_{a} + {e}_{tx 2} + {e}_{rx 1} + {e}_{1211} ) \qquad ( 11 )$$

$$( Math 12 )$$

$${θ}_{V 11} - {θ}_{V 14} = ( {Θ}_{b} + {e}_{tx 1} + {e}_{rx 1} + {e}_{1213} ) - ( {Θ}_{b} + {e}_{tx 2} + {e}_{rx 1} + {e}_{2112} ) \qquad ( 12 )$$

$$( Math 13 )$$

$${θ}_{V 12} - {θ}_{V 15} = ( {Θ}_{c} + {e}_{tx 1} + {e}_{rx 2} + {e}_{1223} ) - ( {Θ}_{c} + {e}_{tx 2} + {e}_{rx 2} + {e}_{2121} ) \qquad ( 13 )$$

Here, when the phase error e_{abcd} is replaced with L_{abcd}*K, the above equations (11) to (13) can be transformed into following equations (14) to (16).

$$( Math 14 )$$

$${θ}_{V 10} - {θ}_{V 13} = - {e}_{tx 2} + {e}_{rx 2} + ( {L}_{1222} - {L}_{1211} ) \cdot K \qquad ( 14 )$$

$$( Math 15 )$$

$${θ}_{V 11} - {θ}_{V 14} = - {e}_{tx 2} + ( {L}_{1213} - {L}_{2112} ) \cdot K \qquad ( 15 )$$

$$( Math 16 )$$

$${θ}_{V 12} - {θ}_{V 15} = - {e}_{tx 2} + ( {L}_{1223} - {L}_{2121} ) \cdot K \qquad ( 16 )$$

When this is converted into a matrix format, the phase difference and the relative phase error of each pair satisfy the relationship expressed by following equation (17).

$$( Math 17 )$$

$$( \begin{matrix}\begin{matrix}{θ}_{V 10} - {θ}_{V 13} \\ {θ}_{V 11} - {θ}_{V 14}\end{matrix} \\ {θ}_{V 12} - {θ}_{V 15}\end{matrix} ) = ( \begin{matrix}- 1 & 1 & {L}_{1222} - {L}_{1211} \\ - 1 & 0 & {L}_{1213} - {L}_{2112} \\ - 1 & 0 & {L}_{1223} - {L}_{2121}\end{matrix} ) \cdot ( \begin{matrix}\begin{matrix}{e}_{tx 2} \\ {e}_{rx 2}\end{matrix} \\ K\end{matrix} ) \qquad ( 17 )$$

Here, a term on a left side of equation (17) is a phase difference vector Y3 between the overlapping virtual antennas V. A first term on a right side of equation (17) is a coefficient matrix A3, and a second term is a phase error vector X3. In equation (17), the phase difference vector Y3 can be calculated from the phase of the peak in each beat signal. The coefficient matrix A3 is a constant matrix defined by a combination of the transmission circuit 3, the receiver circuit 4, and the wiring length difference for each set of the virtual antenna V. Therefore, equation (17) can be solved as a simultaneous equation with eₜₓ₂, eᵣₓ₂, and K as unknowns. That is, the compensator 64 obtains eₜₓ₂, eᵣₓ₂, and K as the solution of equation (17) as the relative phase error of the second transmission circuit 3_2 relative to the first transmission circuit 3_1, the relative phase error of the second receiver circuit 4_2 relative to the first receiver circuit 4_1, and the relative phase error corresponding to the wiring length difference.

In the amplitude compensation process, similarly to the phase compensation process, the compensator 64 defines a linear equation based on the amplitude difference of the peaks of the beat signals for each of Ns+Nr−1 or more pairs of virtual antennas V in which the combination of the transmission circuit 3 and the receiver circuit 4 does not overlap with other pairs, with the amplitude error between the transmission circuits 3 and the receiver circuits 4 being the unknowns. The compensator 64 obtains the solution of this linear equation as the amplitude error.

The amplitude error due to the wiring length difference from the reference wiring length Lo increases linearly according to the wiring length difference from the reference wiring length, similar to the phase error. The increase in amplitude error according to the wiring length difference changes according to temperature. That is, the amplitude error caused by the wiring length difference is equal to a value obtained by multiplying the wiring length difference by a temperature parameter α.

When the amplitude error due to the wiring length difference L_{abcd} is G_{abcd}, a peak amplitude difference A_{V10}−A_{V13} for (V10, V13) can be defined by a relationship shown in equation (18), a peak amplitude difference A_{V11}−A_{V14} for (V11, V14) can be defined by a relationship shown in equation (19), and a peak amplitude difference A_{V12}−A_{V15} for (V12, V15) can be defined by the relationship shown in equation (20).

$$( Math 18 )$$

$${A}_{V 10} - {A}_{V 13} = ( {G}_{a} + {G}_{tx 1} + {G}_{rx 2} + {G}_{1222} ) - ( {G}_{a} + {G}_{tx 2} + {G}_{rx 1} + {G}_{1211} ) \qquad ( 18 )$$

$$( Math 19 )$$

$${A}_{V 11} - {A}_{V 14} = ( {G}_{b} + {G}_{tx 1} + {G}_{rx 1} + {G}_{1213} ) - ( {G}_{b} + {G}_{tx 2} + {G}_{rx 1} + {G}_{2112} ) \qquad ( 19 )$$

$$( Math 20 )$$

$${A}_{V 12} - {A}_{V 15} = ( {G}_{c} + {G}_{tx 1} + {G}_{rx 2} + {G}_{1223} ) - ( {G}_{c} + {G}_{tx 2} + {G}_{rx 2} + {G}_{2121} ) \qquad ( 20 )$$

Here, when the amplitude error G_{abcd} is replaced with L_{abcd}*α, the above equations (18) to (20) can be transformed into following equations (21) to (23).

$$( Math 21 )$$

$${A}_{V 10} - {A}_{V 13} = - {G}_{tx 2} + {G}_{rx 2} + ( {L}_{1222} - {L}_{1211} ) \cdot α \qquad ( 21 )$$

$$( Math 22 )$$

$${A}_{V 11} - {A}_{V 14} = - {G}_{tx 2} + ( {L}_{1213} - {L}_{2112} ) \cdot α \qquad ( 22 )$$

$$( Math 23 )$$

$${A}_{V 12} - {A}_{V 15} = - {G}_{tx 2} + ( {L}_{1223} - {L}_{2121} ) \cdot α \qquad ( 23 )$$

When equations (21) to (23) are converted into a matrix format, the amplitude difference and the relative amplitude error of each pair satisfy the relationship expressed by a following equation (24).

$$( Math 24 )$$

$$( \begin{matrix}\begin{matrix}{A}_{V 10} - {A}_{V 13} \\ {A}_{V 11} - {A}_{V 14}\end{matrix} \\ {A}_{V 12} - {A}_{V 15}\end{matrix} ) = ( \begin{matrix}- 1 & 1 & {L}_{1222} - {L}_{1211} \\ - 1 & 0 & {L}_{1213} - {L}_{2112} \\ - 1 & 0 & {L}_{1223} - {L}_{2121}\end{matrix} ) \cdot ( \begin{matrix}\begin{matrix}{e}_{tx 2} \\ {e}_{rx 2}\end{matrix} \\ α\end{matrix} ) \qquad ( 24 )$$

Here, a term on a left side of equation (24) is an amplitude difference vector Y4 between the overlapping virtual antennas V. A first term on a right side of equation (24) is a coefficient matrix A4, and a second term is an amplitude error vector X2. The amplitude difference vector Y4 can be calculated from the peak amplitude of each beat signal. The coefficient matrix A4 is a constant matrix defined by a combination of the transmission circuit 3, the receiver circuit 4, and the wiring length difference for each set of the virtual antenna V. That is, the compensator 64 obtains Gₜₓ₂, Gᵣₓ₂, and α as the solutions of equation (28) as the relative amplitude error of the second transmission circuit 3_2 with respect to the first transmission circuit 3_1, the relative amplitude error of the second receiver circuit 4_2 with respect to the first receiver circuit 4_1, and the relative amplitude error due to the wiring length.

According to the third embodiment, at least one of the phase difference and the amplitude difference between different transmission circuits, at least one of the phase difference and the amplitude difference between different receiver circuits, and at least one of the phase difference and the amplitude difference corresponding to the wiring length difference between the virtual antennas can be compensated for based on the comparison result between the received signals of the virtual antennas in at least Ns+Nr−1 sets. Therefore, the error compensation processing can be performed for errors between different transmission circuits as well as between different receiver circuits and errors due to the wiring length difference. Furthermore, by arranging at least one of the transmission antennas and the reception antennas at uneven intervals, an aperture length of the virtual antenna can be made larger than in a case where the antennas are arranged at equal intervals. Therefore, both compensation accuracy and spatial resolution can be achieved.

### Fourth Embodiment

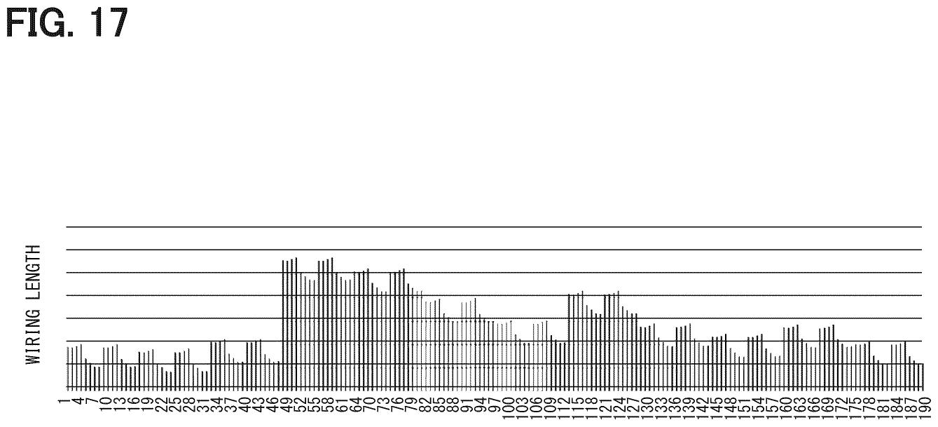

A fourth embodiment shown in FIG. 17 is a modification of the second embodiment.

In the fourth embodiment, the number of the circuits 3, 4 and the number and arrangement of the antennas TX, RX are the same as those in FIG. 9 of the second embodiment. On the other hand, the assumed wiring lengths of the virtual antennas V have a relative relationship shown in a graph of FIG. 17. That is, at least one of the wiring length from each transmission circuit 3 to each transmission antenna TX and the wiring length from each reception antenna RX to each receiver circuit 4 is specified so that the wiring length of the corresponding virtual antenna V has the relative relationship shown in FIG. 17.

Here, since Ns=4 and Nr=4, in the processes of S80 and S90, the control unit 6 further calculates, from the beat signals in at least seven of the belonging groups, the phase error and the amplitude error between the transmission circuits 3, the phase error and the amplitude error between the receiver circuits 4, and the phase error and the amplitude error corresponding to the wiring length difference.

### Other Embodiments

Although a plurality of embodiments have been described above, the present disclosure is not to be construed as being limited to these embodiments, and can be applied to various embodiments and combinations within a scope not deviating from the gist of the present disclosure.

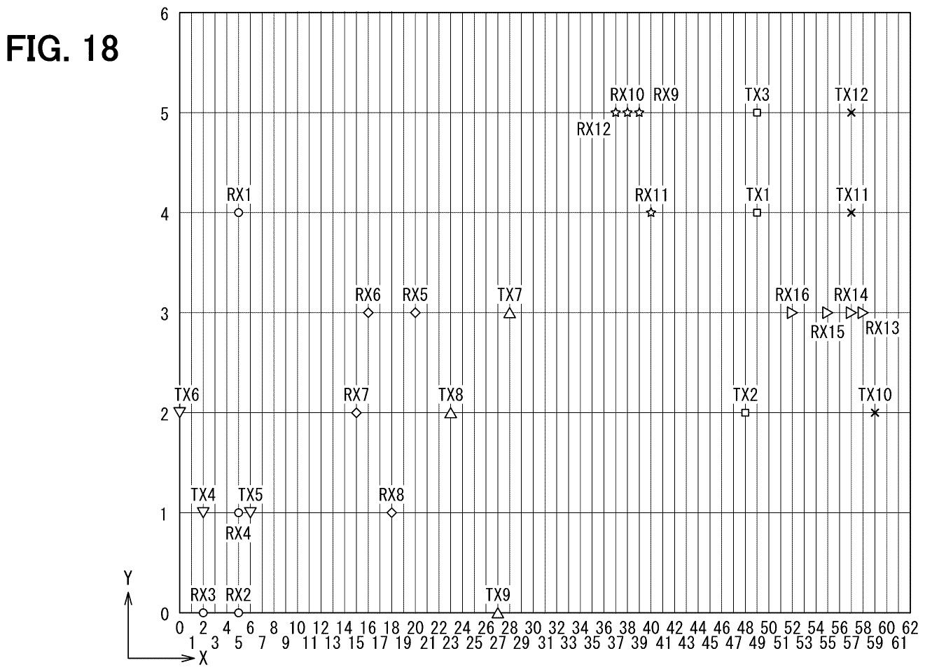

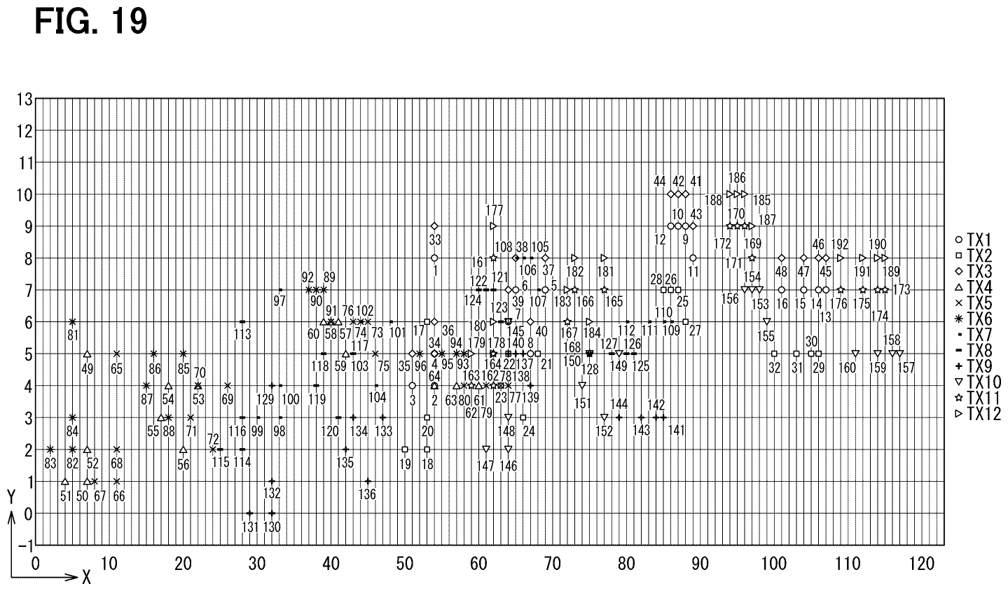

In a modification of the second embodiment, both the transmission antennas TX and the reception antennas RX may be arranged at unequally spaced intervals. More specifically, as shown in FIG. 18, the transmission antennas TX and the reception antennas RX may be arranged two-dimensionally at unequal intervals. In the arrangement shown in FIG. 18, the virtual antenna V is placed at the virtual position shown in FIG. 19.

In a modification, a dedicated computer constituting the control unit 6 may be a sensor control ECU that comprehensively controls types of sensors mounted on the vehicle. The dedicated computer that makes up the control unit 6 may be an integrated ECU, which integrates operational control of the vehicle. The dedicated computer configuring the control unit 6 may be a determination ECU that determines driving tasks in the driving control of the vehicle. The dedicated computer constituting the control unit 6 may be a monitoring ECU that monitors the driving control of the vehicle. The dedicated computer constituting the control unit 6 may be an evaluation ECU that evaluates the driving control of the vehicle. The dedicated computer of the control unit 6 may be a navigation ECU that navigates a travel route of the vehicle. The dedicated computer constituting the control unit 6 may be a locator ECU that estimates a self-state quantity of the vehicle. The dedicated computer that constitutes the control unit 6 may be an actuator ECU that individually controls the travel actuators of the vehicle. The dedicated computer constituting the control unit may be a human machine interface (HMI) control unit (HCU) that controls information presentation in the vehicle. The dedicated computer that configures the control unit 6 may be a computer other than the vehicle, which configures an external center or a mobile terminal that can communicate with the vehicle, for example.

In a modification, the moving object to which the radar device 1 is applied may be, for example, an autonomous robot capable of transporting luggage or collecting information by autonomous driving or remote driving. The autonomous robot includes an autonomous vehicle. In addition to the above-described embodiments and modifications, the present disclosure may be implemented in forms of a control device mountable on a moving object and including at least one processor 6b and at least one memory 6a, a processing circuit (for example, a processing ECU, etc.) or a semiconductor device (for example, semiconductor chip, etc.)

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A radar device comprising:
transmission antennas;
reception antennas;
transmission circuits each connected to the transmission antennas and configured to output transmitted signals;
receiver circuits each connected to the reception antennas and configured to acquire received signals; and
a controller configured to process the received signals, wherein
a number of the transmission antennas is two or more, and is represented by Ns,
a number of the reception antennas is two or more, and is represented by Nr,
the transmission antennas and/or the reception antennas are arranged at unequal intervals,
the transmission antennas and the reception antennas are arranged such that a number of first combinations of the transmission circuit and the receiver circuit is at least Ns+Nr−2,
a first combination is one of the first combinations,
the first combination is determined by first assuming a virtual antenna for each of the transmission antennas based on a phase difference of the received signals between the reception antennas, then extracting a collection of sets of virtual antennas whose virtual positions overlap and whose combinations of the transmission circuits and the receiver circuits do not match, and finally, among the extracted collection, determining, as the first combination, combinations of virtual antennas whose combinations of the transmission circuits and the receiver circuits are not duplicated with those of other combinations, and
the controller is configured to perform a compensation process to compensate for at least one of a phase difference or an amplitude difference between different transmission circuits and at least one of a phase difference or an amplitude difference between different receiver circuits, based on a comparison result of the received signals between the virtual antennas in at least Ns+Nr−2 sets of the first combinations.

2. A radar device comprising:
transmission antennas;
reception antennas;
transmission circuits each connected to the transmission antennas and configured to output transmitted signals;
receiver circuits each connected to the reception antennas and configured to acquire received signals; and
a controller configured to process the received signals, wherein
a number of the transmission antennas is two or more, and is represented by Ns,
a number of the reception antennas is two or more, and is represented by Nr,
the transmission antennas and/or the reception antennas are arranged at unequal intervals,
the transmission antennas and the reception antennas are arranged such that a number of first combinations of the transmission circuit and the receiver circuit is at least Ns+Nr−2, a number of second combinations is at least one, and a total number of third combinations is at least Ns+Nr−1,
a first combination is one of the first combinations,
the first combination is determined by first assuming a virtual antenna (V) for each of the transmission antennas based on a phase difference of the received signals between the reception antennas, then extracting a collection of sets of virtual antennas whose virtual positions overlap and whose combinations of the transmission circuits and the receiver circuits do not match, and finally, among the extracted collection, determining, as the first combination, combinations of virtual antennas whose combinations of the transmission circuits and the receiver circuits are not duplicated with those of other combinations,
a second combination is one of the second combinations,
the second combination is a set of virtual antennas whose virtual positions overlap and whose wiring lengths do not match,
a third combination is one of the third combinations,
the third combination is a set of virtual antennas belonging to at least one of the first combinations or the second combinations, and
the controller is configured to perform a compensation process to compensate for at least one of a phase difference or an amplitude difference corresponding to a wiring length difference between the virtual antennas, at least one of a phase difference or an amplitude difference between different transmission circuits, and at least one of a phase difference or an amplitude difference between different receiver circuits, based on a comparison result of the received signals between the virtual antennas in at least Ns+Nr−1 of the third combinations.

3. The radar device according to claim 1, wherein
the controller is configured to perform the compensation process by further using a comparison result of the received signals between the virtual antennas in a set of virtual antennas in which a combination of the transmission circuits and the receiver circuits are duplicated with those of another set.

4. The radar device according to claim 1, further comprising
a temperature sensor detecting temperatures of the transmission circuits and the receiver circuits, wherein
the controller is configured to:
determine whether the received signal is valid for the compensation process; and
perform the compensation process based on the temperatures of the transmission circuits and the receiver circuits when it is determined that the received signal is not valid for the compensation process.

5. The radar device according to claim 1, wherein
the transmission antennas and the reception antennas are arranged one-dimensionally.

6. The radar device according to claim 1, wherein
at least one of the transmission antennas or the reception antennas is arranged two-dimensionally.
